(19) United States
(12) Patent Application Publication
(10) Pub. No.: US 2002/0043262 A1
(43) Pub. Date: Apr. 18, 2002

(54) Spray device

(76) Inventors: Alan Langford, Hoddesdon (GB); Brian Barney, Bishops Stortford (GB); Caroline Stretton, Harlow (GB)

Correspondence Address: Steve D. Beyer, Beyer Weaver & Thomas, LLP, P.O. Box 778, Berkeley, CA, 94704-0778, US

(21) Appl. No.: 09/935,787

(22) Filed: Aug. 22, 2001

Related U.S. Application Data
(60) Provisional application No. 60/227,149, filed on Aug. 22, 2000.

(51) Int. Cl. B67D 5/06; B67D 5/38

(52) U.S. Cl. 128/200.23; 128/205.23; 215/366; 222/23

(57) ABSTRACT

The present invention relates to a spray device (eg an inhaler) comprising an aerosol formulation administered to the respiratory or nasal tract in which the level of formulation remaining in the device can be readily inspected.

The present invention relates to a respiratory aid adapted to combat more reliably the symptoms of a subject with a respiratory disorder, in particular to a spray device (eg an inhaler) comprising an aerosol formulation administered to the respiratory or nasal tract.

Various respiratory aids are now widely available to a subject wishing to self-administer therapeutic and preventative agents to combat the symptoms of a respiratory disorder such as asthma. These aids come in a range of shapes and sizes to suit the age and ability of the subject. Such respiratory aids include inhalers and auxiliary devices such as spacers, optimisation chambers, reservoirs, expansion chambers and deceleration chambers.

A common example of a respiratory aid is the inhaler which is a manually operated device used to dispense into the respiratory passages a discrete amount of a therapeutic or preventative agent (eg in the form of a spray). One of the benefits of an inhaler is that the subject is able to manage the respiratory disorder through self-administration of a preventative agent. A successful preventative regime relies on regular self-administration of the preventative agent to avert breathing difficulties and other respiratory symptoms. Breathing difficulties may occur suddenly and indiscriminately and their onset frequently leads to a loss in co-ordination. A second benefit of an inhaler is that sudden respiratory attacks may be treated by immediate self-administration of the desired therapeutic agent. The preventative and therapeutic benefits of the inhaler rely on the subject being able to locate reliably and effortlessly an inhaler with an at least partially charged container.

In principle inhalers are available in two types, namely an aerosol device powered by a propellant (eg a metered dose inhaler of the type described in inter alia GB-A-2293110) or a powder containing device (eg a metered dose powder inhaler). The therapeutic or preventative agent may be in dry powder or liquid (eg suspension) form and generally speaking is drawn into the respiratory passages by simultaneously dispensing the agent and taking a sharp intake of breath.

Most forms of aerosol inhaler comprise a metal container for the therapeutic or preventative agent and a discharge valve through which the agent may be dispensed continuously or discretely via a nozzle. For example, conventional metered dose inhalers comprise a metal canister secured to a metered dose valve. A determination of the number of doses remaining in the canister requires a manual record of the number of doses which have been dispensed (for example using a mechanical counter). Many counter devices of a mechanical type have been proposed.

U.S. Pat. No. 3,505,870 discloses a metal aerosol container with a transparent window in a small circular opening in the base.

The present invention is based on the recognition that the welfare of a subject having a respiratory disorder (such as asthma) may be improved by assisting them to rapidly and reliably assess the status of the container. More particularly, the present invention relates to a respiratory aid such as an inhaler adapted so that the subject may rapidly determine how much of the preventative or therapeutic agent remains within the container.

Thus viewed from one aspect the present invention provides a respiratory aid (eg a medical aerosol device) for use in self-administration of an agent for combatting (eg preventing or treating) the symptoms of a respiratory disorder, said respiratory aid comprising: a container for the agent operatively connected to a discharge valve through which a therapeutically or preventatively effective amount of said agent may be dispensed via a nozzle and

an actuator body adapted to actuate the valve, wherein the container comprises:

a glass vial coated with a coating of polymeric material, the coating of polymeric material having at least one clear or translucent portion arranged to permit observation of the level of agent in the container.

Viewed from a further aspect the present invention provides a medical aerosol device comprises a container and a discharge valve through which fluid may be dispensed via a nozzle, an actuator adapted to actuate the valve, the container comprising a glass vial coated with a layer of polymeric material, the polymeric material having at least one clear or translucent portion arranged to permit observation of the level of liquid in the container.

The respiratory aid may be any type of inhaler including one of the group consisting of a pressurised metered dose inhaler (both manually operable and breath actuated), an aerosol inhaler and a dry powder inhaler.

Preferably the actuator is adapted to directly or indirectly administer a therapeutically or preventatively effective amount of said agent into the respiratory passages of a subject through a delivery outlet, said delivery outlet being adapted to fit in the subject's mouth or nose or into an auxiliary device (such as a spacer or an optimisation chamber).

Glass vials have not previously been used for medical aerosol devices because of the risk of breakage if the device is dropped, a risk which is increased in distressed subjects suffering from an asthma attack. Not only are the shards of glass hazardous but the patient may not have a replacement device readily to hand. Thus the use of glass in accordance with the invention is somewhat contrary to conventional wisdom. Application of a polymeric coating may advantageously reduce the risk of injury and distress in the event of breakage.

The polymeric coating may be composed of a polyolefin such as polyethylene, polypropylene, polystyrene or copolymers or blends thereof. Alternative polymers include ABS, acetyl, acrylic and other polymers. Polypropylene is preferred.

In a first embodiment the clear or translucent portion may comprise a window of reduced thickness of polymer coating. The window may be formed by polishing the portion of reduced thickness or by polishing the polymer coating to form a polished portion of reduced thickness.

Alternatively the clear or translucent portion may comprise a portion of increased thickness, the portion being polished to provide a transparent or translucent surface.

Two windows may be provided on opposite sides of the vial to advantageously facilitate transmission of light.

In a preferred embodiment, the clear or translucent portion extends axially of the vial. Gradations or other markings may be provided on or adjacent to the window to indicate the number of doses available.

The device is preferably a metered dose inhaler device or nasal spray.

The container may comprise a conventional metered dose inhaler or nasal spray casing, a window being provided to facilitate observation of the liquid level within the vial. Gradations or other markings may be provided on the casing in addition to or instead of markings on the vial.

The invention is further described by means of example but not in any limitative sense with reference to the accompanying drawings of which:

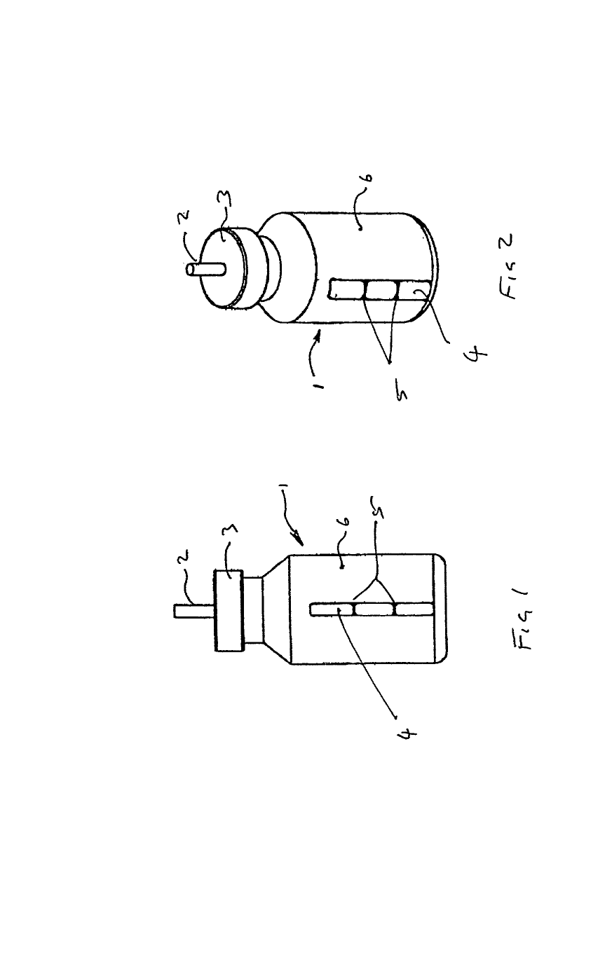

FIG. 1 is an elevation of a vial in accordance with the invention;

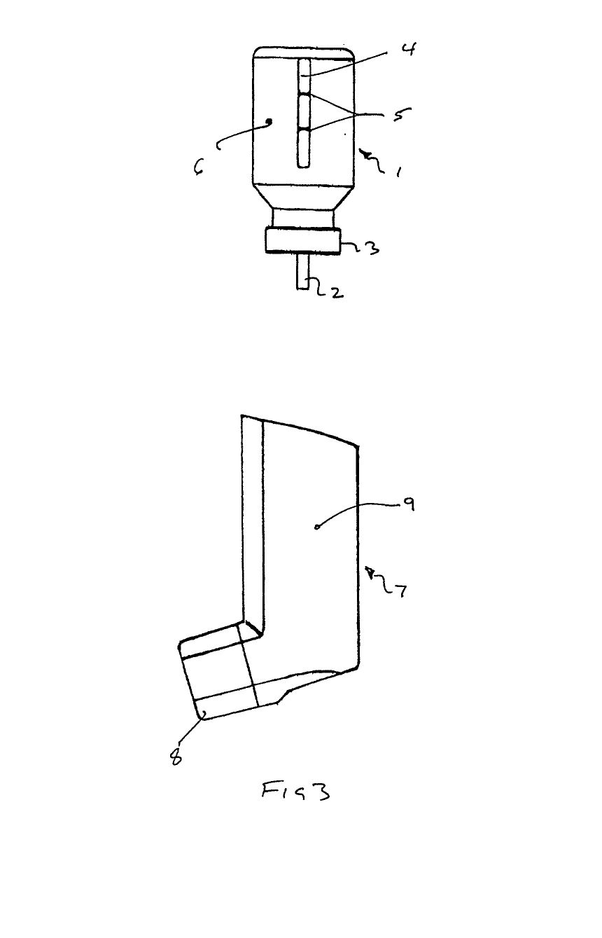

FIG. 2 is a perspective view of the vial shown in FIG. 1;

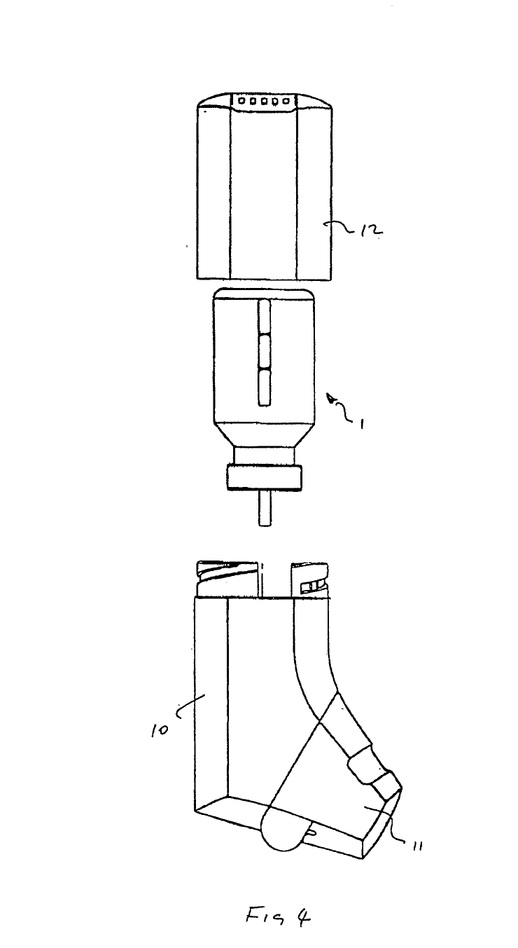

FIG. 3 shows the vial and a metered dose inhaler body;

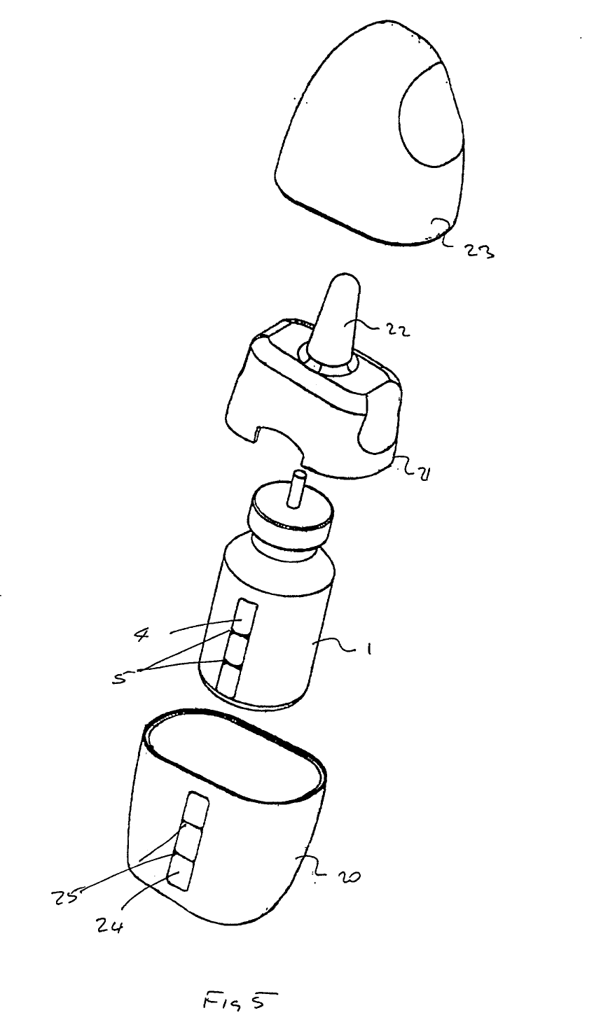

FIG. 4 shows the vial and an alternative metered dose inhaler body; and

FIG. 5 shows the vial with a nasal spray dispenser.

FIGS. 1 and 2 illustrate a vial in accordance with an embodiment of this invention. A glass vial 1 has a conventional aerosol outlet 2 secured by means of a crimped cap 3. The vial 1 is formed of glass with an outer coating of polypropylene 6. A window 4 extending axially of the vial is formed by polishing a portion of the polypropylene coating so that the level of liquid within the vial 1 can be observed. Gradations 5 allow a user to check whether the quantity of liquid available for dispensing is within predetermined maximum and minimum limits.

FIG. 3 shows the vial of FIGS. 1 and 2 inverted for insertion into a conventional metered dose inhaler body 7. The body 7 includes a nozzle 8 defining a mouthpiece 8. The portion 9 of the body 7 into which the vial 1 is inserted may be composed of transparent or translucent material so that the vial 1 can be observed without removal from the body 7.

FIG. 4 illustrates the vial 1 inverted for insertion into a Norton EASI-BREATHE (Registered Trade Mark) metered dose inhaler. The inhaler comprises a body portion 10 adapted to receive the vial 1 and having a pivotable cap 11 which may be opened to facilitate dispensing of the drug. A cap 12 secured to the body 10 may be twisted to prime the metered dose inhaler mechanism (not shown).

In use, the cap 12 may be removed from the body 10 to allow inspection of the vial 1. Alternatively a window (not shown) may be provided in the side of the body 10 to facilitate inspection of the vial 1 without removal from the body 10.

FIG. 5 illustrates a nasal spray device in accordance with an embodiment of this invention. The vial 1 is engaged in a cap 21 having an outlet 22 for insertion into the nasal cavity. The base 20 into which the body of the vial 1 is received incorporates a window 24 having gradations 25. In use the window 4 is aligned with the window 24 so that the level of liquid within the vial 1 may be observed without removing the latter from the base 20.

In this embodiment, the gradations 5 are optional but may serve to confirm to a patient by alignment with the gradations 25 that the vial is correctly inserted into the spray cap 21 and base 20.

1. A respiratory aid for use in self-administration of an agent for combatting the symptoms of a respiratory disorder, said respiratory aid comprising: a container for the agent operatively connected to a discharge valve through which a therapeutically or preventatively effective amount of said agent may be dispensed via a nozzle and an actuator body adapted to actuate the valve, wherein the container comprises:
a glass vial coated with a coating of polymeric material, the coating of polymeric material having at least one clear or translucent portion arranged to permit observation of the level of agent in the container.

2. A respiratory aid as claimed in claim 1 wherein the actuator body is adapted to directly or indirectly administer a therapeutically or preventatively effective amount of said agent into the respiratory passages of a subject through a delivery outlet, said delivery outlet being adapted to fit in the subject's mouth or nose or into an auxiliary device.

3. A respiratory aid as claimed in either of claims 1 or 2 wherein the coating of polymeric material is composed of a polymer selected from the group consisting of a polyolefin, ABS, acetyl and acrylic based polymers.

4. A respiratory aid as claimed in claim 3 wherein the polyolefin is selected from the group consisting of polyethylene, polypropylene, polystyrene and copolymers or blends thereof.

5. A respiratory aid as claimed in claim 3 or 4 wherein the polyolefin is polypropylene.

6. A respiratory aid as claimed in any preceding claim wherein the clear or translucent portion is a window of reduced thickness of the coating of polymeric material.

7. A respiratory aid as claimed in claim 6 wherein the clear or translucent portion is a window obtainable by polishing a portion of reduced thickness of the coating of polymeric material or by polishing the coating of polymeric material to form a polished portion of reduced thickness.

8. A respiratory aid as claimed in any of claims 1 to 5 wherein the clear or translucent portion is a window obtainable by polishing a portion of increased thickness of the coating of polymeric material.

9. A respiratory aid as claimed in any preceding claim comprising two clear or translucent portions of the coating of polymeric material on opposite sides of the glass vial.

10. A respiratory aid as claimed in any preceding claim wherein the clear or translucent portion extends axially of the vial.

11. A respiratory aid as claimed in any preceding claim further comprising indicia adjacent the clear or translucent portion for indicating the number of doses of agent in the container.

12. A respiratory aid as claimed in any preceding claim being an inhaler or nasal spray device.

13. A respiratory aid as claimed in any preceding claim being a metered dose inhaler.

14. A respiratory aid as claimed in any preceding claim wherein the nozzle is an aerosol delivery outlet secured by means of a crimped cap.

15. A respiratory aid as claimed in any preceding claim wherein the vial is at least partially inserted into at least a part of the actuator body.

16. A respiratory aid as claimed in claim 15 wherein in use the clear or translucent portion of the vial is exposed by dislocation or removal of the at least a part of the actuator body.

17. A respiratory aid as claimed in claim 15 wherein in use the clear or translucent portion of the vial is exposed without dislocation or removal of the at least a part of the actuator body.

18. A respiratory aid as claimed in claim 17 wherein the at least a part of the actuator body into which the vial is at least partially inserted is composed at least partially of a transparent or translucent material whereby the clear or translucent portion of the vial is exposed.

19. A respiratory aid as claimed in any of claims 1 to 15 wherein the actuator body comprises: a cover into which is inserted the nozzle end of the vial,
said cover having a delivery outlet for insertion into the nasal cavity; and
a base into which is inserted the opposite end of the vial, said base incorporating a window to permit inspection of the level of agent in the container.

20. A respiratory aid as claimed in claim 19 wherein the base incorporates gradations for indicating the number of doses of agent in the container.

21. A respiratory aid as claimed in claim 19 wherein in use the window in the base is aligned with the clear or translucent portion of the coating of polymeric material on the vial to permit inspection of the level of agent in the container.

22. A respiratory aid as claimed in any of claims 1 to 15 wherein the actuator body comprises:
a cover into which is inserted the nozzle end of the vial, said cover having a delivery outlet for insertion into the mouth, whereby the clear or translucent portion of the vial is exposed without dislocation or removal of the cover.

23. A respiratory aid as claimed in any of claims 1 to 15 wherein the actuator body comprises:
a cover into which is inserted the nozzle end of the vial, said cover having a delivery outlet for insertion into the mouth; and
a base into which is inserted the opposite end of the vial, said base incorporating a window to permit inspection of the level of agent in the container.

24. A respiratory aid as claimed in any of claims 1 to 15 wherein the actuator body comprises:
a cover into which is inserted the nozzle end of the vial, said cover having a delivery outlet for insertion into the mouth; and
a base into which is inserted the opposite end of the vial, said base being detachable to permit inspection of the level of agent in the container.

25. A respiratory aid as claimed in any of claims 22 to 24 wherein the discharge valve is a metered discharge valve.

26. A respiratory aid as claimed in any of claims 22 to 25 wherein the cover is capped with a pivotal cap.

27. A respiratory aid as claimed in claim 25 wherein the base is rotatable to prime the metered discharge valve.

28. A respiratory aid as claimed in any preceding claim wherein the agent is present in a formulation with a propellant.

29. A medical aerosol device comprising a container and a discharge valve through which fluid may be dispensed via a nozzle, an actuator adapted to actuate the valve, the container comprising a glass vial coated with a layer of polymeric material, the polymeric material having at least one clear or translucent portion arranged to permit observation of the level of liquid in the container
